(19) United States
(12) Patent Application Publication
(10) Pub. No.: US 2026/0186938 A1
(43) Pub. Date: Jul. 2, 2026

(54) RELATING PROCESS MODELS

(71) Applicant: INTERNATIONAL BUSINESS MACHINES CORPORATION, Armonk, NY (US)

(72) Inventors: Anuj Gupta, Gurgaon (IN); DEEPAK Gupta, Indirapuram (IN); Mayank Sharma, BANGALORE (IN); Arun Nagarajan, Chennai (IN)

(21) Appl. No.: 19/007,731

(22) Filed: Jan. 2, 2025

(51) Int. Cl. G06F 11/30; G06F 8/51; G06F 11/34

(52) U.S. Cl. CPC G06F 11/3072; G06F 8/51; G06F 11/3476

(57) ABSTRACT

Methods and systems for system incident resolution include converting an event log for an application into event log process information. Source code for the application is converted into source code process information. A unified process model is generated from the event log process information, the source code process information, and an initial process model that is implemented by the application. A problem in execution of the application is resolved based on the unified process model.

### BACKGROUND

The present invention generally relates to machine learning systems and, more particularly, to combining processes with technological factors for automated decision making.

Automated decision making uses machine learning techniques to predict an action that will generate the most favorable outcome in a given instance. For example, reinforcement learning systems may be guided by a process model that establishes rewards for a policy. Actions that correspond to the process model may be rewarded during training, so that the reinforcement learning system makes decisions that lead to good results.

However, the process model is not the only relevant consideration when making decisions in the real world. An optimal decision may be informed by technological factors, which can change rapidly and which can be difficult to account for in a machine learning policy. Additionally, the process model itself may be difficult to characterize and may rely on difficult-to-source subject matter expertise. As a result, automated decision-making systems can have trouble making accurate choices about prioritizing problems and reaching good resolutions to those problems.

### SUMMARY

A method for system incident resolution includes converting an event log for an application into event log process information. Source code for the application is converted into source code process information. A unified process model is generated from the event log process information, the source code process information, and an initial process model that is implemented by the application. A problem in execution of the application is resolved based on the unified process model.

A computer program product includes one or more computer readable storage media and program instructions stored on the one or more computer readable storage media to perform operations. The operations include converting an event log for an application into event log process information, converting source code for the application into source code process information, generating a unified process model from the event log process information, the source code process information, and an initial process model that is implemented by the application, and resolving a problem in execution of the application based on the unified process model.

A computer system includes a processor set, one or more computer readable storage media, and program instructions stored on the one or more computer readable storage media to cause the processor to perform operations. The operations include converting an event log for an application into event log process information, converting source code for the application into source code process information, generating a unified process model from the event log process information, the source code process information, and an initial process model that is implemented by the application, and resolving a problem in execution of the application based on the unified process model.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of multi-source process model determination, in accordance with an embodiment of the present invention;

FIG. 2 is a block/flow diagram of a method for generating synthetic log files for system analysis, in accordance with an embodiment of the present invention;

FIG. 3 is a block/flow diagram of a method for prioritizing and resolving incidents using a unified process model, in accordance with an embodiment of the present invention;

FIG. 4 is a block diagram of a computing environment that can perform multi-source process model determination, in accordance with an embodiment of the present invention;

FIG. 5 is a diagram of a machine learning architecture that can be used to implement part of a process unification model, in accordance with an embodiment of the present invention; and

FIG. 6 is a diagram of a deep machine learning architecture that can be used to implement part of a process unification model, in accordance with an embodiment of the present invention.

### DETAILED DESCRIPTION

Automated decision making systems may be improved by integrating process model information with technological process information. This can help to improve the decision making systems because they will be able to automatically absorb information relating to the process model as well as changing technical circumstances. When addressing a set of incidents, the automated decision making system may prioritize individual incidents based on the impact they have and their urgency, where impact may be measured as an extent of potential damage that the incident may cause and urgency may be measured as a deadline on resolution of the incident.

Process information may be derived from run-time data analysis to collect process modelling information. Static code analysis can be used to derive information about the operation of technological systems. Process modelling can be based on these information sources to document workflows and key metrics and to automate a process. This may include process mapping, which identifies high-level correspondences between process elements and application components, for example documenting entry and exit criteria with expected return code, as well as dependencies. To this end, a machine learning system such as a large language model may be used to combine process model information and technical information.

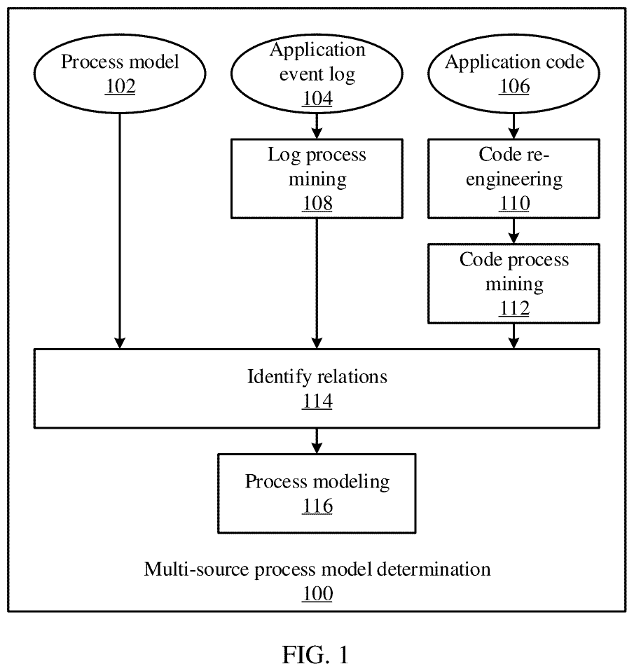

Referring now to FIG. 1, a process for multi-source process model determination 100 is shown. Block 102 represents a process model, which may already be expressed in a process model and notation formal, identifying a workflow for the process with defined steps and decisions. The process model may be generated by any appropriate method, such as by subject matter experts or by automatic process mining.

Log process mining 108 may be performed on an application event log 104. The application event log 104 includes outputs generated by an application used in executing the process, for example detailing actions that the application takes with appropriate notations for inputs and outputs. The application event log 104 may be generated automatically by an application or may be created by aftermarket instrumentation or other monitoring. The log process mining 108 generates an output which may be in a same format as the process model 102. In some cases, the application event log 104 may further include system logs that are generated by the operating system and other applications running on the same system as the application.

Application code 106 undergoes code re-engineering 110 to convert it into a form that can be used for code process mining 112. The application code 106 is analyzed to identify process information that may not be evident from the application event log 104. The output of the code process mining 112 may be in the same format as the process model 102. The code re-engineering 110 seeks to identify events within the application code, such as system calls, that can be represented as parts of a process model. These events are then reframed in the format of the process model to match the other sequences. This process may further include review of application components to better identify sequences.

The process information derived from the process model 102, the application event log 104, and the application code 106 are provided to a generative machine learning system to identify relations 114 between them. The machine learning system may perform a variety of functions, including data augmentation, anomaly detection, pattern recognition, and data synthesis, to accomplish this. The output of the machine learning system may be a unified sequence that fuses the sequences from the different data sources. For example, a high-level event from the process model 102 may be associated with a number of events from the application event log 104 and further with particular functions and system calls in the application code 106. The output of block 114 may thus be an expanded sequence that includes a combination all of the elements from the different sources, with relationships between them identified. Based on the output of the machine learning system, block 116 performs process modeling to generate a new process model that captures the process information from the different sources.

Data augmentation may include augmenting the original application event logs 104 with additional synthetic logs. The synthetic logs may capture the statistical properties of the application event logs 104, such as event frequencies, timestamps, and log patterns, and can be used to increase the size and diversity of the dataset. This helps to improve the accuracy and robustness of correlation systems by providing a larger and more varied dataset to work with. By comparing the application event logs 104 to the synthetic logs, any deviations that are not represented in the synthetic logs can be flagged as potential anomalies, which helps to identify unusual events or behaviors in the logs. The synthetic event logs may further be constructed to represent some known pattern or trend in the application event logs 104 so that the pattern can be studied. By generating synthetic logs based on data from different sources, the integration of logs can be simulated to identify correlations between different log data in a controlled environment.

As used herein, the term “process mapping” may include the creation of a representation of a process flow, for example using flowcharts and/or diagrams. A process map shows a sequence of activities, decision points, and interconnections to provide a clear overview. A process model provides a more detailed and analytical representation of the process, capturing the process flow as well as specific rules, data, and simulations to better characterize the dynamics of the process. Process modeling may be used to predict outcomes, identify inefficiencies, and propose optimizations to the model.

Knowledge articles can be used to provide subject matter expertise regarding the process model. Such articles may include information on systems, applications, workflows, troubleshooting, and other operational aspects, serving as references for learning, problem solving, and process understanding. Knowledge articles may be curated to organize, review, update, enrich, and maintain accuracy and relevance, for example including linking related articles, adding tags for easy searching, and archiving outdated articles.

Issue logs may maintain a record of problems or incidents that have arisen with the application or process over time. Each entry of the issue log may include an issue description, a date and time of occurrence, affected systems, a severity level, and resolution status. These logs may provide historical data for analysis to identify recurring issues and potential root causes, as well ad giving a reference point for troubleshooting current issues.

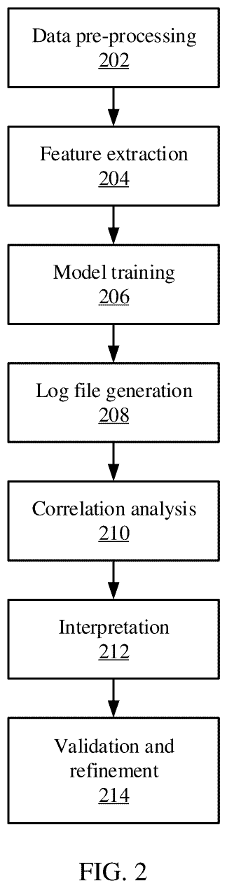

Referring now to FIG. 2, a method for correlating process information with a machine learning model is shown. Block 202 performs pre-processing on the information derived from the process model 102, the application event log 104, and the application code 106. The pre-processing 202 may include standardizing formats, normalizing timestamps, and removing irrelevant or redundant data. The pre-processing 202 may therefor make use of text parsing, data extraction, and data cleaning processes.

Block 204 extracts features from the process information, such as timestamps, log types, error codes, keywords, and other information that may be used as inputs to a machine learning model. The machine learning model may be implemented as, for example, a recurrent neural network (RNN) model or transformer model, which processes sequential input data and outputs a new sequence that fuses elements of the inputs according to relations that the model identifies. Block 206 trains the model using the extracted features across a large dataset of process information from different sources. The model is trained to generate synthetic process information (e.g., synthetic logs) based on the patterns it has learned. The model may be a generative machine learning model, such as a large language model (LLM). In the case of an LLM, the training 206 may include fine-tuning a pre-trained model to provide it with specific information relevant to the application. The model is trained 206 to identify correlations, detect patterns, and generate synthetic log sequences that resemble the original data. This model may be the same model as was used to identify relations between sequences, as in block 114 above.

The model generates synthetic sequences based on patterns and relationships it has learned from input sequences during training 206. The synthetic sequences mimic the structure and behavior of the input data, reflecting similar relationships and dependencies, without being exact replicas. For example, if certain events in the input sequences tend to follow a specific order, the synthetic sequences will reflect that pattern.

Block 208 uses the trained model to generate synthetic log files, for example resembling the process information that is gleaned from the process model 102, the application event logs 104, and/or the application code 106. The synthetic log files may have similar structure and content to this original process information.

Block 210 performs a correlation analysis on the synthetic log files using, e.g., statistical methods and/or machine learning, to identify patterns or relationships among log file data. This correlation analysis 210 may involve time-series analysis, clustering, or association rule mining. Block 212 then provides an interpretation of the correlation analysis. For example, correlated log data may be visualized using charts or graphs to aid in interpretation. Domain experts can further analyze and interpret the correlations to gain insight into system behavior, anomalies, and trends. Block 214 performs validation and refinement of the correlation results using domain expertise, for example by iteratively fine-tuning the machine learning model as needed to improve the accuracy and relevance of its outputs.

The correlation analysis 210 identifies patterns and relationships in the log, such as how events are connected or how one action leads to the next. It uncovers insights into system behavior, detects anomalies, and can predict potential issues. For example, if the correlation analysis 210 determines that certain errors occur together, the system can automatically trigger resolutions or preventative measures based on that insight.

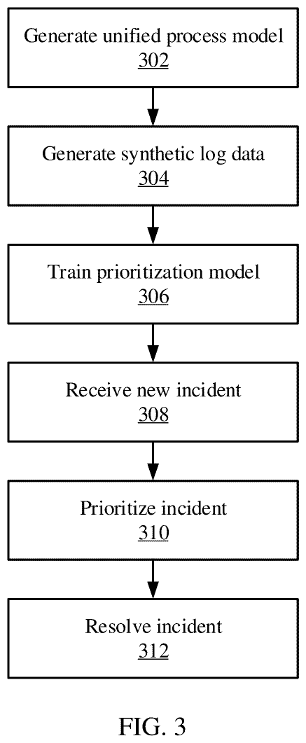

Referring now to FIG. 3, a method for prioritizing and resolving incidents is shown. Block 302 generates a unified process model, for example making use of the multi-source process model determination. The unified process model includes relations between various sources of process information so that problems that are identified at a high level of abstraction can be related to their low-level causes. Block 304 generates synthetic log data based on the unified process model, for example using a generative machine learning model to produce synthetic logs which may be variations on the unified process model that have similar behavior. Block 306 uses the unified process model and the synthetic logs to train a prioritization model.

The prioritization model may take as input information about an incident, for example a failure in a particular part of the process model, and may generate a priority for the incident. For example, the incident may be prioritized according to its type and its urgency. The training may be based on a knowledge base that shows past failures, the urgency associated with particular types of failure, and the impact that the failures have had. In some cases, predetermined logic may be used to identify the impact and urgency. For example, priority weights may be assigned according to where a problem originates, between the application, a database, storage, and performance metrics. If problems are reported in multiple areas, then priority may be assigned according to the predetermined logic.

Block 308 receives information about a new incident. For example, the application log for a process may indicate a particular failure has occurred. Block 310 prioritizes the incident, along with any other incidents that have occurred. Block 312 uses the priority information to resolve the incidents. For example, if the application reports that a particular action has failed, the unified process model may indicate that this failure is the result of running out of storage space. This may be regarded as a high-priority incident, as it will affect other processes as well. Block 312 may automatically act to resolve the problem, for example by deleting temporary files to free storage space. Thus block 312 may perform an action that changes the state of the computing system, for example by starting or stopping a process, by changing a configuration setting of the application, or by changing a property of the computing environment (e.g., free storage).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as multi-source process model determination 419. In addition to block 419, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 419, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

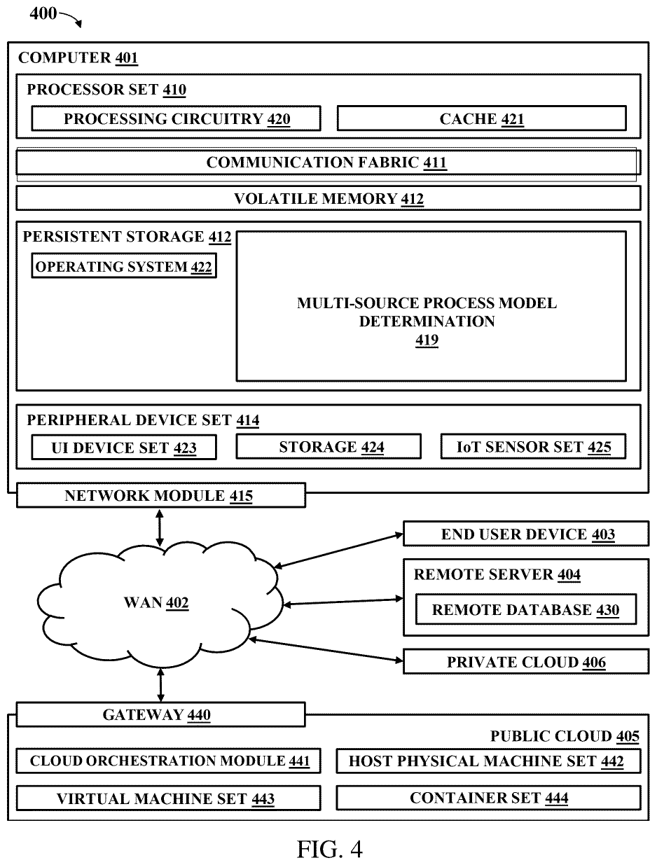

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 419 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 419 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

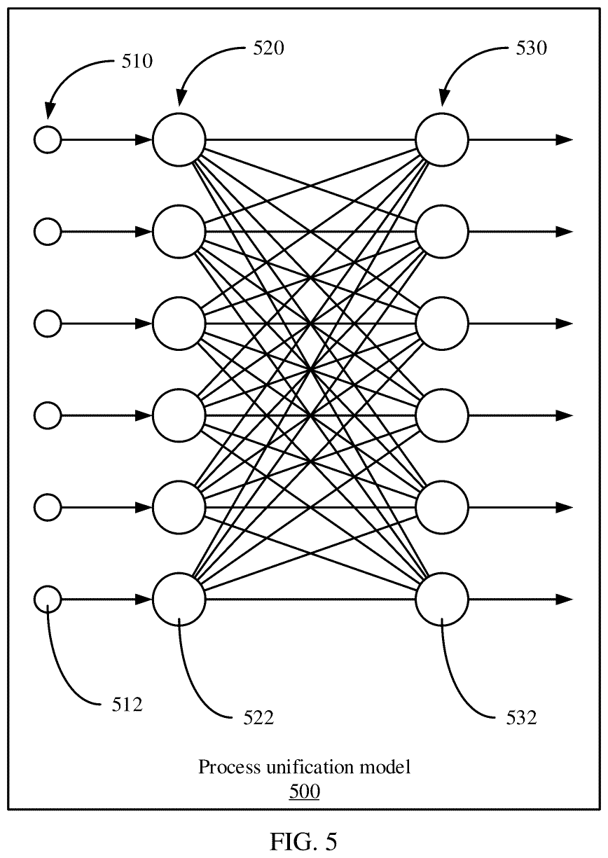

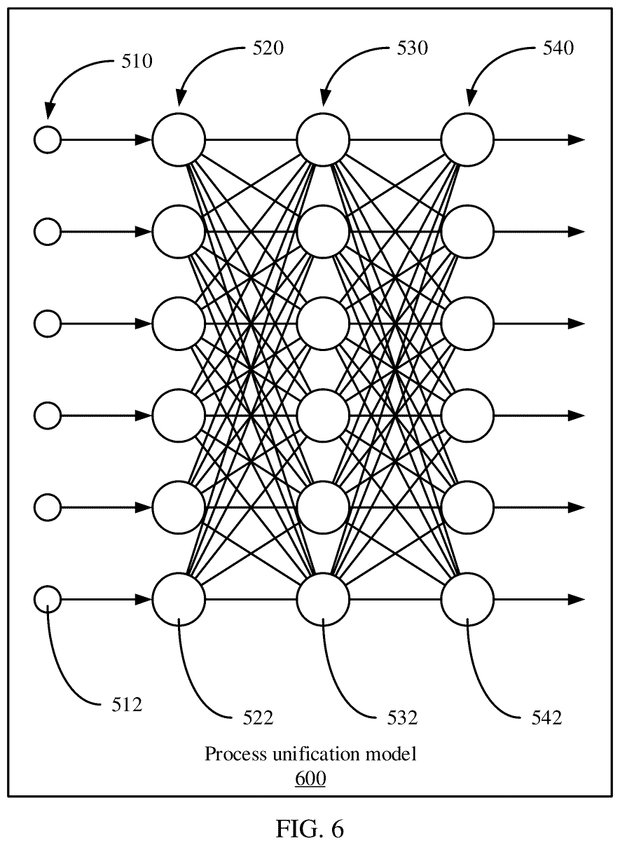

Referring now to FIGS. 5 and 6, exemplary neural network architectures are shown, which may be used to implement parts of the present models, such as predictive model 500/800. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . w_{n-1,} wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of relating process models (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for system incident resolution, comprising:
converting an event log for an application into event log process information;
converting source code for the application into source code process information;
generating a unified process model from the event log process information, the source code process information, and an initial process model that is implemented by the application; and
resolving a problem in execution of the application based on the unified process model.

2. The method of claim 1, wherein converting the event log into event log process information includes translating to a same format as the initial process model.

3. The method of claim 1, wherein converting the source code into source code process information includes translating to a same format as the initial process model.

4. The method of claim 1, further comprising generating synthetic logs based on the unified process model.

5. The method of claim 1, further comprising generating synthetic log data using the unified process model.

6. The method of claim 5, further comprising training a machine learning model to detect and prioritize problems using the synthetic log data.

7. The method of claim 6, wherein resolving the problem includes performing an automatic action in accordance with a priority of the problem.

8. The method of claim 7, wherein the automatic action includes one or more of starting or stopping a process, changing a configuration setting of the application, or changing a property of a computing environment.

9. The method of claim 1, wherein generating the unified process model includes identifying relations between elements of the event log, elements of the source code, and elements of the initial process model.

10. The method of claim 9, wherein the relations identify elements of the source code that implement elements of the initial process model.

11. A computer program product, comprising:
one or more computer readable storage media; and
program instructions stored on the one or more computer readable storage media to perform operations comprising:
converting an event log for an application into event log process information;
converting source code for the application into source code process information;
generating a unified process model from the event log process information, the source code process information, and an initial process model that is implemented by the application; and
resolving a problem in execution of the application based on the unified process model.

12. A computer system, comprising:
a processor set;
one or more computer readable storage media; and
program instructions stored on the one or more computer readable storage media to cause the processor to perform operations comprising:
converting an event log for an application into event log process information;
converting source code for the application into source code process information;
generating a unified process model from the event log process information, the source code process information, and an initial process model that is implemented by the application; and
resolving a problem in execution of the application based on the unified process model.

13. The computer system of claim 12, wherein converting the event log into event log process information includes translating to a same format as the initial process model.

14. The computer system of claim 12, wherein converting the source code into source code process information includes translating to a same format as the initial process model.

15. The computer system of claim 12, wherein the operations further comprise generating synthetic logs based on the unified process model.

16. The computer system of claim 12, wherein the operations further comprise generating synthetic log data using the unified process model.

17. The computer system of claim 16, wherein the operations further comprise training a machine learning model to detect and prioritize problems using the synthetic log data.

18. The computer system of claim 17, wherein resolving the problem includes performing an automatic action in accordance with a priority of the problem.

19. The computer system of claim 12, wherein generating the unified process model includes identifying relations between elements of the event log, elements of the source code, and elements of the initial process model.

20. The computer system of claim 19, wherein the relations identify elements of the source code that implement elements of the initial process model.
